(19) United States
(12) Patent Application Publication
(10) Pub. No.: US 2014/0344344 A1
(43) Pub. Date: Nov. 20, 2014

(54) PRE-FETCHING IN DISTRIBUTED COMPUTING ENVIRONMENTS

(71) Applicant: Microsoft Corporation, Redmond, WA (US)

(72) Inventors: Brian C. Beckman, Newcastle, WA (US); Henricus Johannes Maria Meijer, Mercer Island, WA (US); Jeffrey Van Gogh, Redmond, WA (US); Danny Van Velzen, Redmond, WA (US)

(21) Appl. No.: 14/445,216

(22) Filed: Jul. 29, 2014

Related U.S. Application Data
(63) Continuation of application No. 11/932,723, filed on Oct. 31, 2007.

(51) Int. Cl. H04L 29/08

(52) U.S. Cl. CPC H04L 67/2847; H04L 67/02; H04L 67/1097; H04L 67/26
USPC 709/203

(57) ABSTRACT

Client-side performance is optimized through server-side pushing of content. Portions of content are requested and retrieved as required by a client-side application. Moreover, content likely to be needed in the near future is pre-fetched and pushed to the client. This is beneficial from an overhead standpoint since all content need not be provided to the client at once. Rather, content provisioning is throttled based on need, and wait time is mitigated by pre-fetching.

### CROSS-REFERENCE TO RELATED APPLICATIONS

This application claims priority to and is a continuation of co-pending U.S. patent application Ser. No. 11/932,723 entitled “Pre-Fetching in Distributed Computing Environments” and filed Oct. 31, 2007, which is incorporated herein by reference.

### BACKGROUND

Computer programming refers to the process of producing computer programs or applications. Computer programs are groups of instructions specified in one or more programming languages that describe actions to be performed by a computer or other processor-based device. When a computer program is loaded and executed on computer hardware, the computer will behave in a predetermined manner by following the instructions of the computer program. Accordingly, the computer becomes a specialized machine that performs the tasks prescribed by the instructions.

Several technologies exist to optimize programs as a function of the scenario in which they are used. Most of these performance optimizations involve dynamic and sometimes static analysis of the program to determine which blocks of code are utilized most often. A compiler then consumes this tracing data and produces a new version of the program where the most popular blocks are emitted in a way that these blocks will be loaded/executed in a faster way at runtime. Even though these techniques have proven very useful in the past, they have several downsides. First, only certain scenarios are optimized while other might suffer performance degradation. Additionally, since dynamic analysis uses tests that execute certain scenarios in the code, these tests have to be carefully written and selected to ensure the proper scenarios are optimized. Thirdly, writing these tests and selecting scenarios to optimize can be a huge cost, and writing the tooling for such analysis is also expensive.

Increasingly, computer programming or coding is shifting away from single devices and toward distributed systems. Client/server architectures of the past have reemerged as a dominant computing paradigm thanks to advances in network communication as well advent of the Internet. Moreover, development is moving toward software as a service. Here, applications are designed as network accessible services. Service consumers reside on a client and communicate with server providers over communication networks such as the Internet.

The World Web (simply the Web) is based on a distributed architecture. The Web is a system of interlinked documents accessible over the Internet. Client devices include Web browsers that facilitate presentation of web pages including text, images, sound, video, and/or programs. More specifically, a web browser connects to a web server at a particular address over the Internet and requests a web page and/or associated content designated at that address. In response, the web browser transmits the entire web page and/or related content to the browser for subsequent presentation and/or execution. Conventionally, web browsing can be optimized by caching content on the client side. For example, after retrieving a web page, the entire page can be cached such that if needed again the page can be quickly acquired from cache memory rather than the longer process of requesting and receiving the page over the Internet.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains pre-fetching in a distributed computer environment. In accordance with one aspect of the disclosure, rather than downloading all content (e.g., code, data . . . ) associated with a distributed application from a server at once, portions of content can be downloaded or otherwise acquired by a client in a piecemeal manner on an as needed basis. To mitigate delay associated with cross network or communication framework retrieval, content likely to be needed in the near future can be pre-fetched and pushed to a client according to another aspect of the disclosure. As a result, client side application processing is optimized or at least improved.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a distributed computer system in accordance with an aspect of the disclosed subject matter.

FIG. 2 is a block diagram of a representative pre-fetch component according to an aspect of the disclosure.

FIG. 3 is an exemplary conceptual view of a use structure in accordance with an aspect of the disclosed subject matter.

FIG. 4 is a block diagram of a representative context component according to an aspect of the disclosure.

FIG. 5 is a block diagram of a representative client application component according to an aspect of the disclosed subject matter.

FIG. 6 is a block diagram of a pre-fetch system in accordance with an aspect of the disclosed subject matter.

FIG. 7 is a block diagram of a compilation system according to an aspect of the disclosure.

FIG. 8 is a flow chart diagram of a server method in accordance with an aspect of the disclosed subject matter.

FIG. 9 is a flow chart diagram of a client method in accordance with an aspect of the disclosed subject matter.

FIG. 10 is a flow chart diagram of a content pre-fetch method according to an aspect of the disclosed subject matter.

FIG. 11 is a schematic block diagram illustrating a suitable operating environment for aspects of the subject disclosure.

FIG. 12 is a schematic block diagram of a sample-computing environment.

### DETAILED DESCRIPTION

Systems and methods are described hereinafter relating to pre-fetching in a distributed computer environment. Rather than requiring all content to be transmitted to a client for execution at once, portions of the content can be judiciously transmitted. This improves client side processing speed since it does not need to wait for a large quantity of data to be transmitted prior to beginning execution especially where some content is unlikely to be utilized. Furthermore, content can be automatically pre-fetched and pushed to a client by a server such that needed content is readily available without communication framework interaction.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

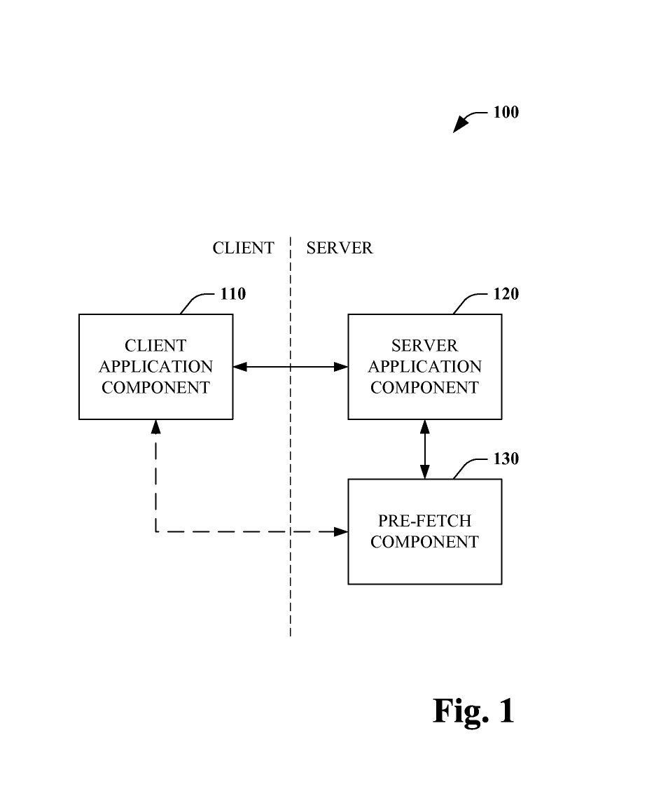

Referring initially to FIG. 1, a distributed computer system 100 is illustrated in accordance with an aspect of the claimed subject matter. The system is divided by a dashed line into a client side and a server side. On the client side, a client application component 110 is provided. On the server side, a server application component 120 is depicted together with a pre-fetch component 130. The client application component 110 and server application component 120 can interact with each other over a network such as but not limited to the Internet or other communication framework. The client application component 110 can provide, present, process, and/or otherwise execute content (e.g., data, text, audio, video, code . . . ) provided by the server component 130. The server application can also process and execute content on the server side as well as provision data to the client application component 110. In one instance, the client application component 110 can be a web browser application and the server application component 120 can be a web server application. However, the appended claims are not limited thereto.

Interaction between the client application component 110 and the server application component 120 can be iterative in nature. In other words, instead of transmitting all content portions, blocks or chunks of content are requested and delivered as needed. As a result, load time is reduced thereby enabling the client application component 120 to begin processing content earlier. This is beneficial from an overhead standpoint because all content including that which may be unlikely to be utilized need not be downloaded at once. The down side is that some slow down can occur when content is first loaded. However, the pre-fetch component 130 addresses this issue.

The pre-fetch component 130 provides content likely to be needed in the near future via the server application component 120 or directly. The mechanism determines or infers content likely to be needed automatically utilizing affinity matrices, statistical analysis, machine learning, and/or administrative configuration, among other things. In operation, if a client application component 110 requests content, that content as well as additional content that may be need for future processing is provided in response. Suppose, for example, it is known or it can be determined that “X” and “Y” are related. If the client requests “X,” then the pre-fetch component 130 can identify “Y” and both “X” and “Y” can be pushed to the client. This can also be recursive such that if “Z” is related to “Y,” then “X,” “Y,” and “Z,” can be provided in response to a request for “X.” However, the extent of pre-fetching can be limited explicitly, by space limitations or time constraints, among other things. It should also be noted that a byproduct of piecemeal interaction in combination with pre-fetching is reduced network traffic, which can improve transmission speed and thus client server interaction.

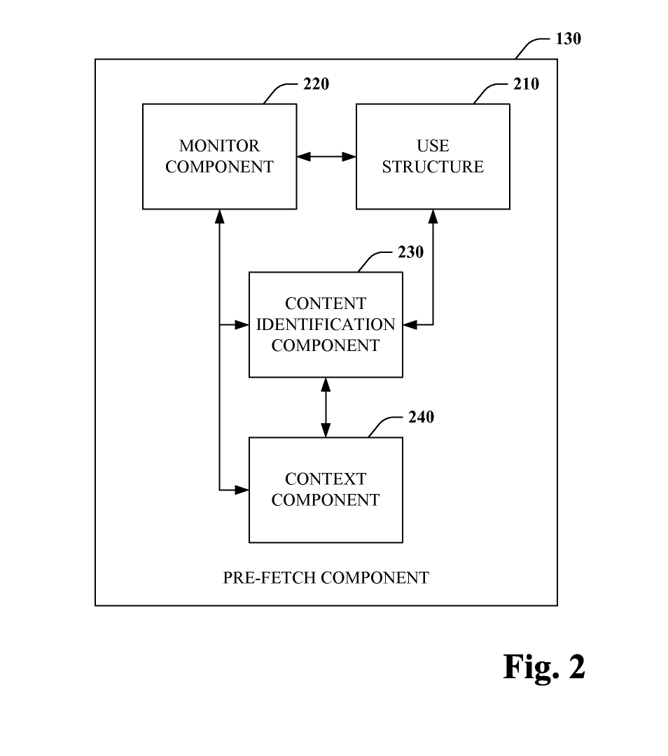

FIG. 2 illustrates a representative pre-fetch component 130 in accordance with an aspect of the claimed subject matter. The pre-fetch component 130 can include a structure component 210 and a monitor component 220. The structure component 210 defines application usage patterns and associated content. For a given client and server application, all possible usage scenarios including the content related thereto can be captured. The monitor component 210 can observe application execution relative to the structure. This can assist in identifying future potential content for pre-fetching.

The system 200 also includes content identification component 230 communicatively coupled to the monitor component 220 and structure component 210. The content identification component 230 is a mechanism for identifying content to be pushed to a user, for example in addition to requested content. Information from the monitor component 220 and structure component 210 aid identification by affording potential usage paths and relative content as a function of current application execution state. Identification of a particular path and content can be determined utilizing statistical, machine learning, and/or administrative configuration, among other things. For example, it can be determined, inferred, or otherwise known that one path is more likely than another. As a result, if confronted with a choice, the content identification path component 230 can select the most likely path and content associated with that path.

Additionally, system 100 can also include context component 240 coupled to the content identification component 230 and optionally the monitor component 220. The context component 240 receives, retrieves, or otherwise acquires or obtains contextual information, for example regarding a client, user, historical usage, etc. Such information can be provided or made available to the content identification component 230 to aid identification of relevant content. Further, context information can be provided or made available to the monitor component 220 to influence the range of information that is relevant to pre-fetching given a current state.

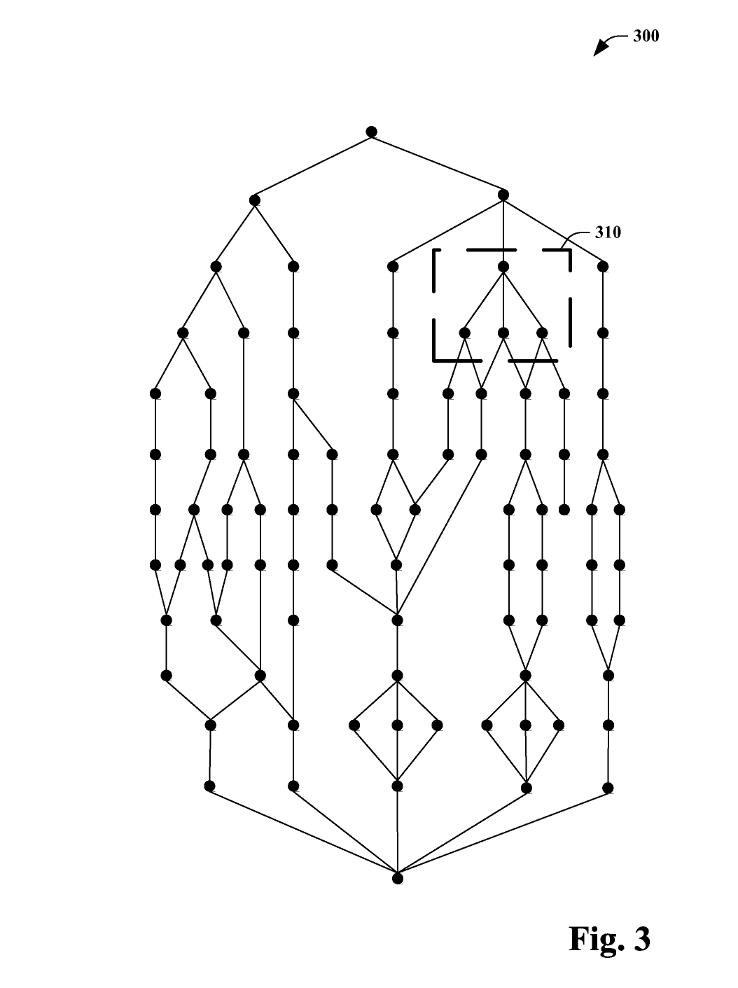

Referring to FIG. 3 an exemplary conceptual representation of a use structure 300 is depicted in accordance with an aspect of the claimed subject matter. As shown, a graph can be utilized as a use structure to capture client and server application functionality. Each node in the graph can represent a particular state and have content or content information associated with it. The lines between nodes denote potential execution and/or processing paths. Current state and relevant paths can be tracked utilizing a window 310 over a subset of the graph. This window can slide over the graph to identify relevant branches and associated nodes as program state changes as a result of execution. Further, the window size can vary depending on the amount of metadata or other information desired. For example, if client resources are substantially thin then the window size can be smaller as less information will need to be provisioned with respect to pre-fetching. Likewise, the window size can be larger for clients with substantial resources. The goal is to predict a path though the graph structure and ensure whatever branch is actually taken will be available on the client.

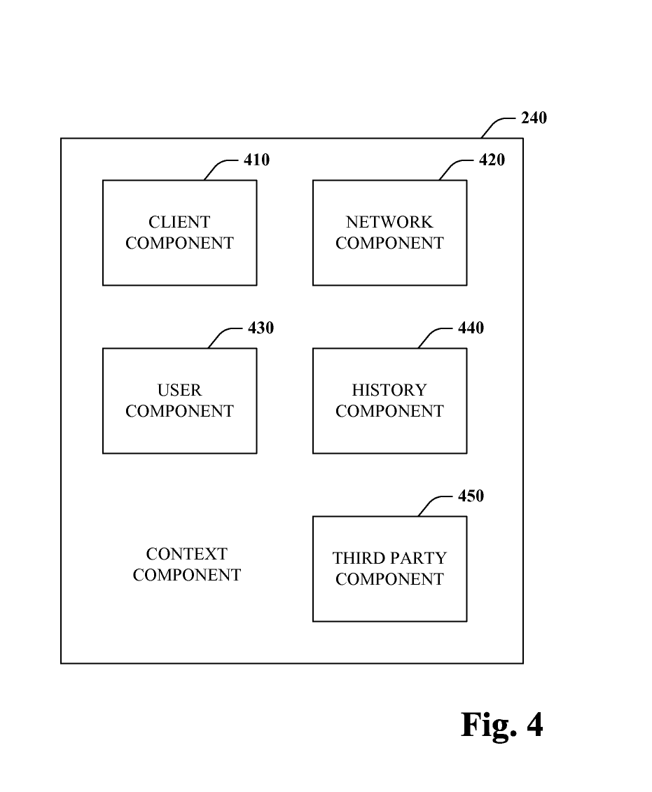

FIG. 4 is a representative context component 240 in accordance with an aspect of the claimed subject matter. As previously mentioned, context component 240 can play a significant role in pre-fetching by assisting identification of content for pushing, among other things. The context component 240 can include or be embodied by many components or sub-components including client component 410, network component 420, user component 430, history component 440, and third party component 450, among others. Each component can receive, retrieve or otherwise obtain or acquire a particular form of contextual data. Additionally or alternatively, the components can generate context information from other contextual information acquired by the same or different components. Obtained as well as generated information can be afforded to assist identification of content for pre-fetching, as previously described.

The client component 410 acquires and/or produces data pertaining to a client device. For example, it can determine whether a device is a thin client with limited processing power or fat client with more resources. Furthermore, the client component might identify specific computational resources available or not available (e.g., processor, processor power, memory, software . . . ). Still further yet, current or substantially real-time information can be acquired relating to load, resource allocation, and/or resource utilization, among other things.

The network component 420 affords context information related to a communication path between a client and the server. It can provide information regarding network bandwidth and latency. Further, the network component 410 can identify and optionally acquire information related to a network address such as an Internet protocol (IP) address. This could assist in identifying other information such as geographical information of a client and/or server, among, inter alia.

User demographic information can be obtained or acquired utilizing user component 430. In this case, information about a user such as age, gender, race, ethnicity, religion, group affiliation, and/or educational level, etc. can be afforded by the system. This information can be supplied explicitly by users and/or inferred as a function of other information provided or not provided.

The history component 440 tracks historical usage data. In one instance, web browser history can be stored and utilized to aid pre-fetching operations. Furthermore, historical client/server application interaction can be a useful source of information. Applications include a plethora of execution paths, not all of which are utilized by every user. By tracking usage, some paths can be eliminated as unlikely thereby improving the odds that an identified path and associated content will be utilized.

The third party component 450 acquires information pertaining to application interaction by others. As a distributed application, many users can interact with instances of the application. Their interaction can be monitored and utilized for improving pre-fetch operation. For example, if a particular path and associated content are more popular than others with a majority of application users, this can factor in its selection for pre-fetching. Similarly, if a path and content are rarely employed, this can negatively impact the chances of it being pre-fetched.

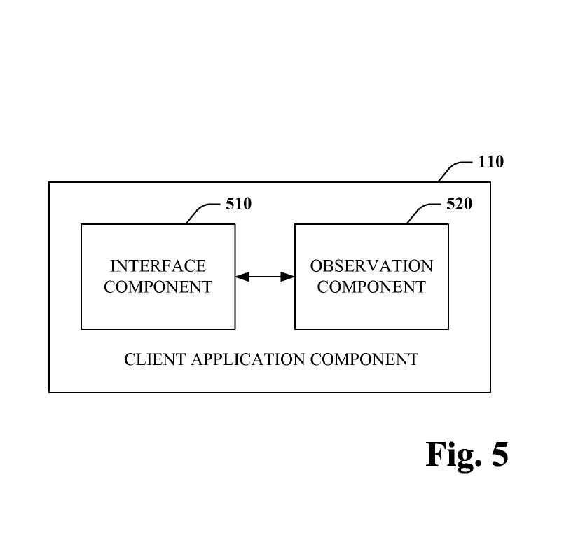

FIG. 5 depicts a representative client application component 110 in accordance with an aspect of the claimed subject matter. The client application component 110 operates on a client side machine and interacts with a corresponding service application component 120 as shown and described with respect to FIG. 1. Interface component 510 enables this interaction. For example, the interface component 510 can request and receive or retrieve content provided by a server application. Moreover, the interface component 510 is adapted to receive more content than is requested. This enables the client application component 110 to accept pre-fetched content pushed to it.

The interface component 110 can also optionally include an observation component 520. While information can be collected and utilized to affect pre-fetching on the server side, the client side application component 110 can also assist in this process. The observation component 520 can collect information or metadata surrounding client side application and provide it to the client side application component 120 and/or pre-fetching component 130 (FIG. 1). By way of example, the observation component 520 can observe and report processing statistics related to the pre-fetching in various scenarios. Additionally or alternatively, dwell and/or processing time can be monitored and provided to affect the extent of pre-fetched content. For instance, if it is know that a user dwells on content for ten seconds, then that is the time that can be utilized to pre-fetch and push additional content to the client application 110.

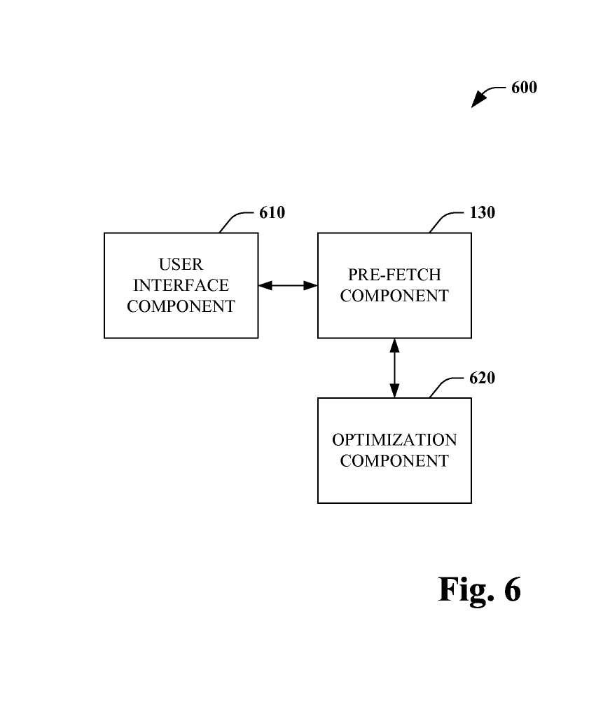

Turning to FIG. 6, a pre-fetch system 600 is illustrated in accordance with an aspect of the claimed subject matter. As shown, the system 600 includes a pre-fetch component 130 that is operable to identify and push content to client applications to facilitate processing. As previously described, the pre-fetch component 130 can be employed on a server side to push content likely of being needed in the future to a client to mitigate any wait time associated with piecemeal interaction.

The system 600 can also include a user interface component 610 communicatively coupled to the pre-fetch component 130. The user interface component 610 provides a mechanism to allow users such as administrators to customize or fine-tune pre-fetching. This enables users to specify pre-fetching algorithms or otherwise control operation thereof For example, an administrator may tweak the importance of various axes utilized to decide which content to push. These decisions can be made after a set of reports is provided on the effectiveness of pre-fetching.

The pre-fetch component can also include an optimization component 620 to enable automatic fine-tuning of pre-fetching as a function of performance for instance. More specifically, the optimization component 620 can measure the effectiveness of pre-fetching and use this information to update the pre-fetching process for future application runs. In one particular embodiment, the optimization component 620 can choose to instrument a client or content acquired by the client to measure effectiveness.

It is to be noted as well as appreciated that the aforementioned pre-fetching mechanisms can be configured for different client server applications and/or content types. In accordance with one embodiment, the mechanism can apply to programmatic code executing on a client that might need to be optimized. Every time a client needs to run a piece of code that it has not yet loaded, it can request this code from a server. The server can then utilized knowledge that it has built up concerning the program over time, for example based on requests and runs from the same or other clients, to send one or more pieces of code to the client. As it is allowed to send multiple pieces of code at once, it can use this mechanism to push code to the client that the server expects the client will need in the near future thus removing the load time when an event occurs, for example. In one particular instance, the client can be an application running in a browser and the server is a web service running on a server. It should also be noted that client and server could be on the same machine (e.g., different application domains, processes . . . ) or a far apart as the other side of the world. Further, the processing units can be of any unite size including but not limited to instruction, method, type, block, and assembly, among others.

For purposes of clarity and understanding, consider programmatic code that utilizes type as the iterative unit. Every time a client needs to use a type the client has not received in that instance of the program, the client asks the server for this type. The client should expect to receive that type as required and a number of extra types. Accordingly, the server can decide when the client should receive which type. Consider further the following C# application that may be converted to JavaScript and executed on the client:

public class Foo
{

Input i;
public void Main( )
{

i = new Input( );
Document.Body.AppendChild(i);
Button b = new Button( );
b.Click += Validate;
Document.Body.AppendChild(b);

}
public void Validate( )
{

If (i.Value == “Test”)
{

Window.Browser.Alert(“Running tests...”);
Tester t = new Tester( );

}
else
{

Div d = Div( );
d.InnerText = ”order is being processed.”;
Order o = new Order( );

}

}

}

When this program is run for the first time, it can be executed without any optimization. The server receives a request for each type when it is first used and sends only one type to the client at a time. Every time it receives a request, it will store this information in some data repository. The next time the program is run; the server already has knowledge about this program and can serve up the code in a smarter way. For example, it can decide that whenever the user requests the “Window” type, to also send the “Tester” type, as it knows from previous experience that the two are needed almost instantaneously.

The server could use one or more algorithms to decide which types to send together including but not limited to some form of affinity matrix, machine learning, statistical analysis, and/or administrator configured grouping of type. The server can use several axes to make decisions on including: which machine is executing the client; which user is executing the client; which browser is executing the client; the response time of communication between server and client; download throughput between client and server; performance of the client; library code sent, and/or which application is using the library, among others. Of course, combinations are also possible.

In accordance with another particular embodiment relating to code, it is to be appreciated that client side code can be optimized by not downloading error handling until needed. Error handling comprises a large portion of programmatic code and it is typically invoked infrequently in comparison to other code. Accordingly, a client/server application can be instructed to only download error handling as needed. Further, pre-fetching can be configured to ignore error-handling branches unless actually invoked in which case units of error handing code can be pre-fetched to expedite processing of errors.

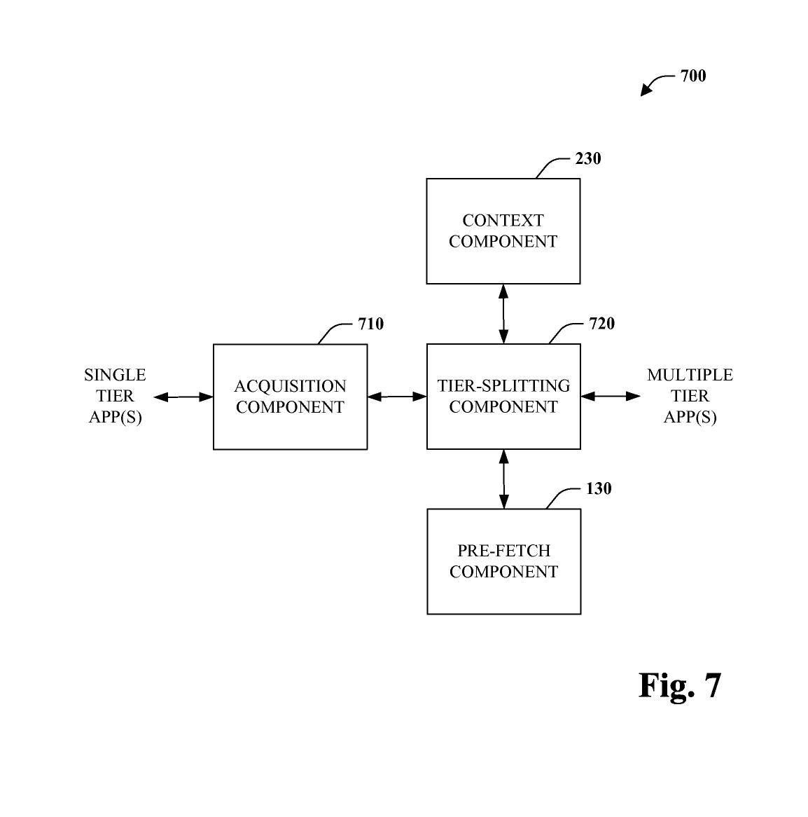

Turning to FIG. 7, a compilation system 700 is depicted that can be employed together with aspects of the claimed subject matter. Conventionally, monolithic client and server application code is developed in isolation. However, this need not be the case. As shown here, a single tier application can be developed and acquired by the acquisition component 710. Subsequently, tier splitting component 720 employing context information provided by context component 230 can split a single application into multiple tiers such as client and server. In this manner, application execution performance can be optimized by optimizing use of tiered resources. This as well as other functionality can be performed by a compiler.

The pre-fetch component 130 can receive, retrieve, or otherwise obtain information about an application from the tier splitting component 720 or other compilation component(s). Since an application is first developed as a single tier application and later split and deployed on a client and server, for instance, the pre-fetch component 130 can obtain global application knowledge. Intimate knowledge can be obtained about the entire application (e.g., instructions, blocks, types, method boundaries, exception handling envelopes, continuations . . . ), which is useful in generating a use structure, among other things.

It is to be appreciated the mechanisms described herein are not limited to the case in which content programmatic code. Other embodiments are also possible including, without limitation, multimedia, games, and the like. For example, suppose one is streaming music and it is known or can be determined that a user has particular preferences or play list algorithm for moving to the next song. The server and client could utilize this knowledge to stream music in a piecemeal fashion utilizing pre-fetching to eliminate delays.

In another instance, consider an online gaming environment. The server could collect data on play patterns of users. Not every user utilizes every action of feature of a game. In fact, only a limited number actually do. Accordingly, a play pattern can identify an affinity for particular actions in particular situations. For example, in an American football game one user may almost always pass the ball rather than run. In this case, only plays relevant to the passing game need be resident on a client. The running game can be streamed if and when needed.

In yet another instance, consider a travel web site that assists in booking flights, hotels, and rental cars. The system can learn that every time an individual books a flight they also book both a hotel and a rental car. After a flight-booking module is downloaded, chunks associated with hotels and cars can be downloaded in the background while the individual is filling out flight information. Accordingly, there is no waiting when the individual moves on to the hotel and car rental portions. The pre-fetched portions include not just code but data. For example, images associated with hotels and cars can be downloaded. This can be further optimized by considering the individual's destination from the flight portion as well as hotel and car preferences, among other things.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the pre-fetch component 130 can employ such mechanism to facilitate identification of content to be pushed to a client, for instance.

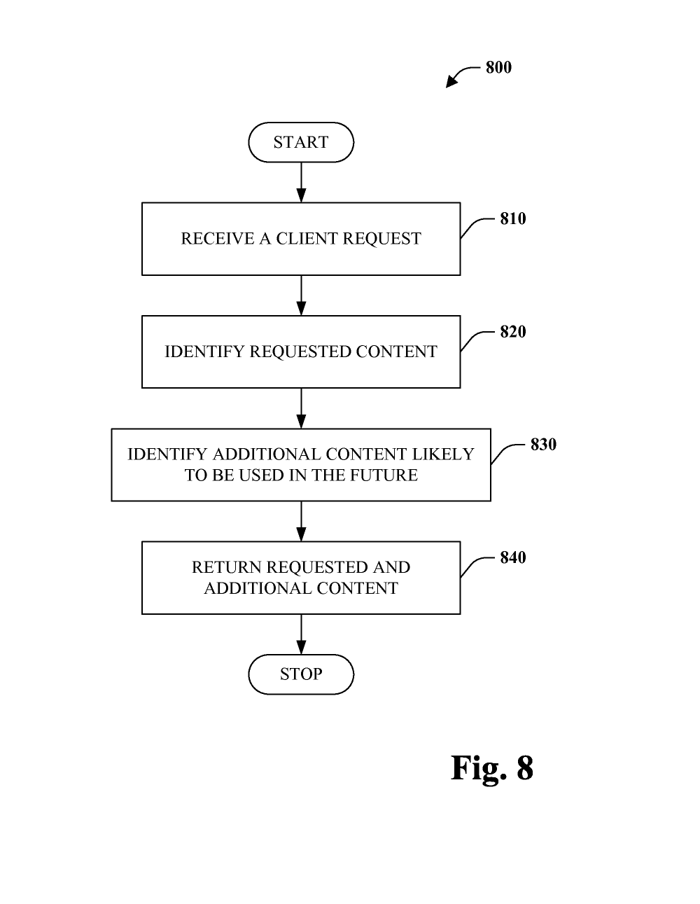

In view of the exemplary systems described supra, methodologies that may be implemented in accordance with the disclosed subject matter will be better appreciated with reference to the flow charts of FIGS. 8-10. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 8, a server method 800 is provided in accordance with an aspect of the claimed subject matter. At reference numeral 810, a client request is received. The request can be for a needed unit of content (e.g., code type, method, block . . . ). The requested content can be identified at 820. At numeral 830, additional content likely to be needed in the future is identified. One or more mechanisms such as statistical analysis, machine learning, or administrative configurations can be employed together with context information to determine or infer content of likely to be needed. At reference numeral 840, requested and additional content are provided or returned to the client.

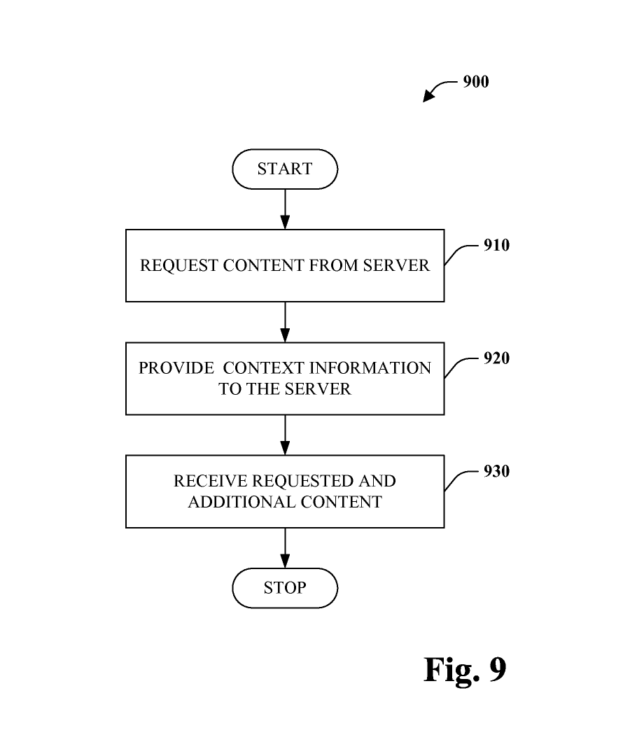

FIG. 9 is a flow chart diagram of a client method 900 in accordance with an aspect of the claimed subject matter. At reference numeral 910, content is requested from a server. In accordance with one aspect provided herein, not all content need be loaded at once. Rather, content can be provided in a piecemeal fashion to facilitate processing, execution, presentation or the like.

At numeral 920, context information collected through client side observation can be provided to the server to aid client/server interaction. For example, the context information can relate to application processing including performance statistics, dwell time, and the like. However, context is not limited thereto. Any set of facts or circumstances surrounding distributed computation are fair game including without limitation information pertaining to a client device, user, and/or communication network.

At reference 930, requested and additional content is received from the server. The additional content is content that the client may need in the near future. Instead of pushing solely requested content, the server can be proactive and push additional content likely to be needed to mitigate delay associated with later retrieval thereof. As a result, a client should be able to accept this additional content when provided. Furthermore, prior to requesting content the client should check client side memory or storage for the data since it might already be local, thereby eliminating the need to retrieve it externally.

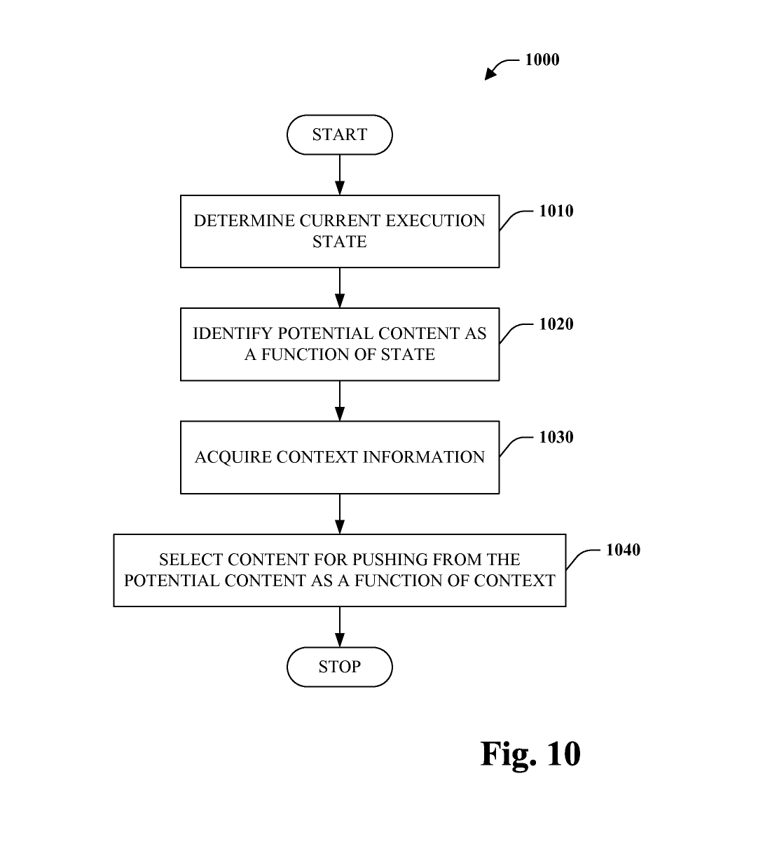

Turning attention to FIG. 10, a pre-fetch method 1000 is shown in accordance with an aspect of the claimed subject matter. At reference numeral 1010, current execution state is determined or otherwise identified. In one embodiment, content is provided on an as needed basis rather than pushing all content associated with a particular application over at once. Hence, the current execution state can be tracked on the server side as a function of content previously provided. Furthermore, a usage structure that defines an application usage patterns can be utilized to aid identification of execution state. At reference 1020, potential content can be identified as a function of state. For example, the usage structure can be employed here. Once state is known all potential paths and associated content associated therewith can be identified. Additionally or alternatively, an affinity matrix may be employed here to identify potentially related content. Context information is acquired at numeral 1030. Content information can include but is not limited to network bandwidth, network latency, IP address, date, time, local information, history, client capabilities, and/or user demographics. At reference numeral 1040, content is selected for pushing from identified potential content as a function of context information, among other things. Statistical analysis, machine learning, or the like can be employed to predict content likely needed from potential content and context information. Additionally or alternatively, explicitly encoded relationships, algorithms or the like employed to identify content.

As used herein, the terms “component,” “system” and the like are intended to refer to a computer-related entity, either hardware, a combination of hardware and software, software, or software in execution. For example, a component can be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers. It is to be noted that services, tests, or test consumers can be components as defined herein.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

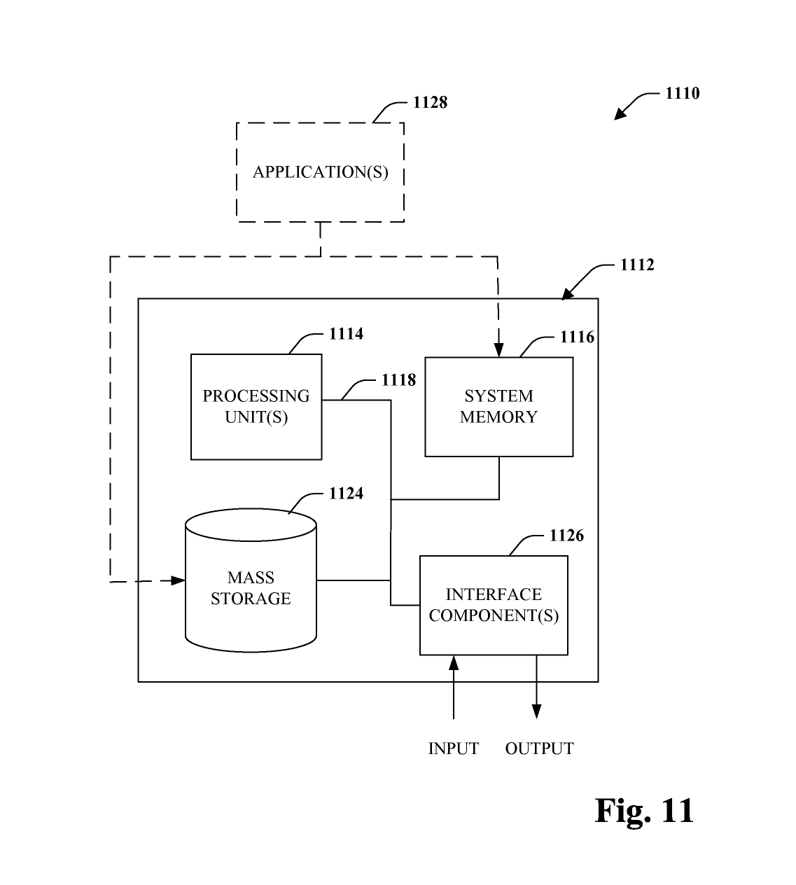

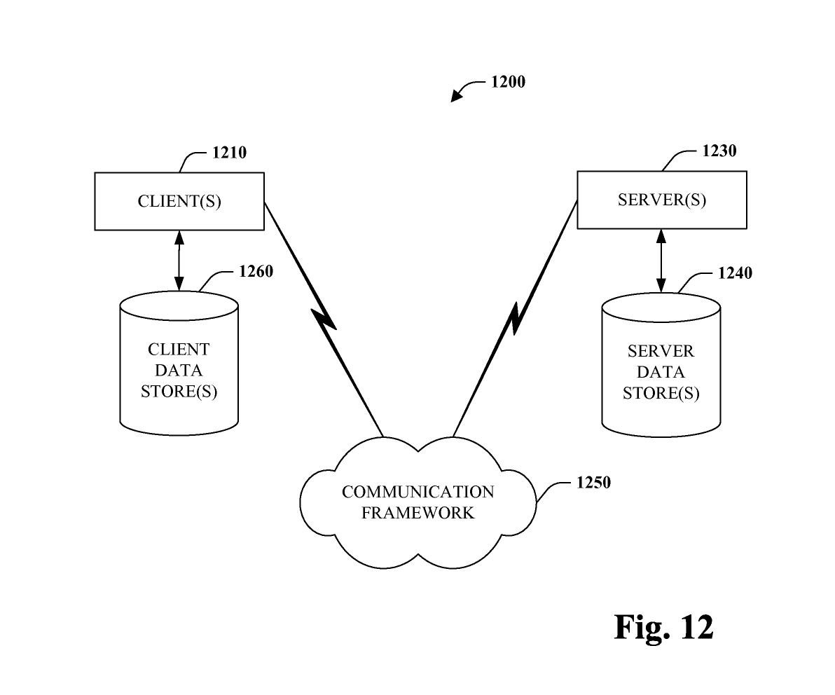

In order to provide a context for the various aspects of the disclosed subject matter, FIGS. 11 and 12 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 11, an exemplary environment 1110 for implementing various aspects disclosed herein includes a computer 1112 (e.g., desktop, laptop, server, hand held, programmable consumer or industrial electronics . . . ). The computer 1112 includes a processing unit 1114, a system memory 1116, and a system bus 1118. The system bus 1118 couples system components including, but not limited to, the system memory 1116 to the processing unit 1114. The processing unit 1114 can be any of various available microprocessors. It is to be appreciated that dual microprocessors, multi-core and other multiprocessor architectures can be employed as the processing unit 1114.

The system memory 1116 includes volatile and nonvolatile memory. The basic input/output system (BIOS), containing the basic routines to transfer information between elements within the computer 1112, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1112 also includes removable/non-removable, volatile/non-volatile computer storage media. FIG. 11 illustrates, for example, mass storage 1124. Mass storage 1124 includes, but is not limited to, devices like a magnetic or optical disk drive, floppy disk drive, flash memory, or memory stick. In addition, mass storage 1124 can include storage media separately or in combination with other storage media.

FIG. 11 provides software application(s) 1128 that act as an intermediary between users and/or other computers and the basic computer resources described in suitable operating environment 1110. Such software application(s) 1128 include one or both of system and application software. System software can include an operating system, which can be stored on mass storage 1124, that acts to control and allocate resources of the computer system 1112. Application software takes advantage of the management of resources by system software through program modules and data stored on either or both of system memory 1116 and mass storage 1124.

The computer 1112 also includes one or more interface components 1126 that are communicatively coupled to the bus 1118 and facilitate interaction with the computer 1112. By way of example, the interface component 1126 can be a port (e.g., serial, parallel, PCMCIA, USB, FireWire . . . ) or an interface card (e.g., sound, video, network . . . ) or the like. The interface component 1126 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1112 to output device(s) via interface component 1126. Output devices can include displays (e.g., CRT, LCD, plasma . . . ), speakers, printers and other computers, among other things.

FIG. 12 is a schematic block diagram of a sample-computing environment 1200 with which the subject innovation can interact. The system 1200 includes one or more client(s) 1210. The client(s) 1210 can be hardware and/or software (e.g., threads, processes, computing devices). The system 1200 also includes one or more server(s) 1230. Thus, system 1200 can correspond to a two-tier client server model or a multi-tier model (e.g., client, middle tier server, data server), amongst other models. The server(s) 1230 can also be hardware and/or software (e.g., threads, processes, computing devices). The servers 1230 can house threads to perform transformations by employing the aspects of the subject innovation, for example. One possible communication between a client 1210 and a server 1230 may be in the form of a data packet transmitted between two or more computer processes.

The system 1200 includes a communication framework 1250 that can be employed to facilitate communications between the client(s) 1210 and the server(s) 1230. The client(s) 1210 are operatively connected to one or more client data store(s) 1260 that can be employed to store information local to the client(s) 1210. Similarly, the server(s) 1230 are operatively connected to one or more server data store(s) 1240 that can be employed to store information local to the servers 1230.

Client/server interactions can be utilized with respect with respect to various aspects of the claimed subject matter. In fact, client/server interactions provide a foundation for many aspects. More particularly, processing can be split across client(s) 1210 and server(s) 1230 communicatively coupled by communication framework 1250. Units of content can be transmitted from the server(s) 1230 to client(s) 1210 as needed. Furthermore, to mitigate delay some content can be pre-fetched by server(s) 1230 and pushed to client(s) 1210.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

What is claimed is:

1. A distributed computer system, comprising a memory having computer executable components stored thereon, and a processor communicatively coupled to the memory, the processor configured to execute the computer executable components, the computer executable components including:
an application component distributed across a client and a server; and
a pre-fetch component of the server that automatically identifies and pushes content likely to be needed to the client to facilitate client side application processing based on dwell time of a user on a client device.

2. The system of claim 1, wherein pre-fetching is applied to programmatic code of a distributed application, a portion of the distributed application executing on the client.

3. The system of claim 1, wherein the pre-fetch component is configured to ascertain content associated with at least one of a plurality of potential execution paths.

4. The system of claim 1, further comprising a monitor component configured to monitor a current state of the application with respect to a use structure, wherein the use structure defines application execution and identifies execution paths and associated content.

5. The system of claim 4, further comprising a context component configured to identify context information related to an execution of the application.

6. The system of claim 5, wherein the pre-fetch component is configured to ascertain content associated with at least one of the plurality of potential execution paths as a function of the current state and the context information.

7. The system of claim 1, further configured to process a client request identifying particular content associated with the application.

8. The system of claim 1, wherein the pre-fetch component is configured to identify content associated with the application according to various levels of granularity.

9. The system of claim 1, wherein the pre-fetch component is configured to determine a pre-fetch strategy as a function of global knowledge about the application prior to being split across the client and the server.

10. The system of claim 1, wherein the pre-fetch component further automatically identifies and pushes content likely to be needed to the client based on at least one of network bandwidth, network latency or processing time of the client device.

11. The system of claim 1, wherein the pre-fetch component further automatically identifies and pushes content likely to be needed to the client based on a user-specified pre-fetching algorithm controlling operation of pre-fetching by the server.

12. The system of claim 1, further comprising a history component that tracks and stores historical usage data which is used by the pre-fetch component to automatically identify and push content likely to be needed to the client.

13. The system of claim 12, wherein the pre-fetch component eliminates an execution path as unlikely based upon the historical usage data.

14. A client/server interaction method, comprising employing a processor to execute computer executable instructions stored on a computer readable storage medium to implement the following acts:
identifying content requested by a client application;
pre-fetching additional content by a server by identifying content likely to be needed by the client to facilitate client side application processing based on at least one of network bandwidth, network latency, processing time of the client device or a user-specified pre-fetching algorithm controlling operation of pre-fetching by the server; and
returning the requested and additional content to the client application.

15. The method of claim 14, further comprising monitoring an execution of the application to determine a current execution state.

16. The method of claim 14, further comprising identifying content associated with the application according to various levels of granularity.

17. The method of claim 14, further comprising receiving information pertaining to a context of the application from the client.

18. The method of claim 14, wherein pre-fetching is applied to programmatic code of a distributed application, a portion of the distributed application executing on the client.

19. The method of claim 14, further comprising receiving an input from the client specifying a manner in which content associated with the application is selected.

20. A computer-readable storage medium storing instructions, the instructions configured to, in response to execution by at least one computing device, cause the method of claim 14 to be performed.

21. The method of claim 14, further comprising requesting and receiving a particular content related to the application.

22. The method of claim 14, further comprising providing context information to a server, wherein the context information relates to an execution of the application on the client.
